(19) United States
(12) Patent Application Publication
(10) Pub. No.: US 2005/0078951 A1
(43) Pub. Date: Apr. 14, 2005

(54) Driving device and information processing apparatus utilizing same

(75) Inventors: Junichi Furukawa, Tokorozawa-shi (JP); Kiyoshi Tateishi, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/948,285

(22) Filed: Sep. 24, 2004

(30) Foreign Application Priority Data
Sep. 30, 2003 (JP) P2003-341549

(51) Int. Cl. H04N 5/50

(52) U.S. Cl. 386/126

(57) ABSTRACT

A driving device includes a superimposing unit, a reference clock signal generating unit and a control unit. The superimposing unit superimposes a superimposed signal on a driving signal that drives an optical beam radiating unit for radiating an optical beam, and outputs the driving signal, on which the superimposed signal is imposed, to the optical beam radiating unit. The reference clock signal generating unit generates a reference clock signal. The control unit keeps a frequency of the superimposed signal constant on a basis of a feedback system utilizing the reference clock signal thus generated.

### BACKGROUND OF THE INVENTION

1. Field of the Invention

The present invention relates to a driving device and an information processing apparatus utilizing same, and more particularly to the driving device, which drives an optical beam radiating unit for radiating an optical beam, to radiate the optical beam, and the information processing apparatus, which utilizes such a driving device to carry out record or reproduction of information.

2. Related Art

When information is recorded on an optical recording medium such as a DVD (Digital Versatile Disc) or reproduced therefrom, a laser beam is typically utilized as an optical beam for recording/reproducing information. A laser diode is used as an element for radiating the optical beam, in the light of the facts that it is compact and available at a low cost.

Although the laser diode radiates a laser beam in a so-called single mode in many instances, the laser diode is usually driven in a so-called multiple-mode in record/reproduction of the optical information according to the conventional prior art, in order to reduce noises included in the laser beam itself. Accordingly, a superimposed signal having a preset frequency is usually superimposed on a driving signal for driving the laser diode prior to an operation of inputting the driving signal to the laser diode, in order to enable the laser diode to be driven in the multiple-mode.

It is known that variation in frequency of the superimposed signal itself due to its temperature characteristics may lead to increase in noise, even when the laser diode radiates the laser beam in the multiple-mode. However, with respect to the red laser diode conventionally utilized for recording information on a DVD or reproducing the information therefrom, even when noise increases in the vicinity of the predetermined intensity required for, e.g., reproduction of information, due to variation in frequency of the superimposed signal as shown in FIG. 1A (such a frequency is referred to as “superimposed frequency” in FIG. 1A) (see a broken line in FIG. 1A), noise having a noise level, which is less than a permissible noise level in reproduction of information, is merely generated, exerting substantially no influence on a reproduction operation itself. Accordingly, there has been no need to take any measures to cope with variation in frequency of the superimposed signal itself, as long as the conventional red laser diode was utilized.

On the other hand, there has recently been proposed an optical disc having a recording capacity enhanced remarkably in comparison with the conventional DVD, and a blue-violet laser diode has been utilized as the source for recording information on the optical disc or reproducing the information therefrom. Such a blue-violet laser diode is also driven with the use of a driving signal on which a superimposed signal is superimposed so as to enable an operation to be made in a multiple-mode for the purpose of reduction of noise, in the similar manner as the conventional red laser diode.

However, according to experiments made by the inventors of the present application, it was recognized that an amount of noise generated in conjunction with variation in frequency of the superimposed signal as mentioned above with the use of the blue-violet laser diode was larger than that generated with the use of the red laser diode (see FIG. 1B). It was also recognized that, although noise was generated in the vicinity of the predetermined intensity required for, e.g., reproduction of information, the noise component of the blue-violet laser diode exceeded the permissible noise level in reproduction of the information (see FIG. 1B). In addition, it was recognized the blue-violet laser diode provided output characteristics, which were different from the red laser diode (see FIG. 1B).

Influences on the noise component of the laser beam exerted by variation in frequency of the superimposed signal itself may usually be reduced by enhancement of the intensity (power) of the laser beam itself. However, this leads to enhancement of an optical beam for reproduction, when reproducing information from a rewritable optical disc, so that recording pits formed on the optical disc for the record of information may be deformed or extinguished, thus erasing the information as originally recorded when reproducing the information.

Under such circumstances, there has been a strong demand for development of technique, which permits to reduce noise of the laser beam itself operated in a multiple-mode in a reliable manner, even when the intensity is low, in a case where the blue-violet laser diode is utilized.

### SUMMARY OF THE INVENTION

An object of the present invention, which was made to solve the above-mentioned problems, is therefore to provide a driving device for a laser diode, which permits to prevent, even when the intensity is low, the frequency of a superimposed signal for noise reduction from becoming unstable to cause the noise, and an information processing apparatus, which utilizes such a driving device to carry out record or reproduction of information.

In order to attain the aforementioned object, the driving device according to one of the aspects of the present invention comprises: a superimposing unit for superimposing a superimposed signal on a driving signal that drives an optical beam radiating unit for radiating an optical beam, and outputting the driving signal, on which the superimposed signal is imposed, to the optical beam radiating unit; a reference clock signal generating unit for generating a reference clock signal; and a control unit for keeping a frequency of the superimposed signal constant on a basis of a feedback system utilizing the reference clock signal thus generated.

The control unit may be a phase-locked loop unit that keeping the frequency constant based on the reference clock signal.

The reference clock signal generating unit may generate the reference clock signal on a basis of a signal that varies depending upon a type of recording medium on which the optical beam is radiated.

The reference clock signal generating unit may generate the reference clock signal on a basis of a signal that varies depending upon any one of operations, which are to be carried out, of recording information on a recording medium utilizing the optical beam and of reproducing the information from the recording medium utilizing the optical beam.

The reference clock signal generating unit may comprise a quartz oscillating section to generate the reference clock signal.

The reference clock signal generating unit may generate, when recording information on a recording medium with a wobble track, which permits an optical record/reproduction of information, utilizing the optical beam and reproducing the information from the recording medium utilizing the optical beam, the reference clock signal on a basis of a wobbling clock signal obtained by detecting a wobbling frequency in the wobble track.

The reference clock signal generating unit may generate, when reproducing information from a reproduction-only optical recording medium utilizing the optical beam, the reference clock signal on a basis of a reproduction clock signal obtained by reproducing the information.

The device according to the present invention may further comprises: a frequency control unit for modifying a frequency division ratio in a frequency dividing section included in the phase-locked loop unit, to control the frequency.

The frequency control unit may control the frequency based on the frequency of the reference clock signal and the frequency division ratio.

In order to attain the aforementioned object, the information processing apparatus according to another aspect of the present invention comprises: a driving device comprising: a superimposing unit for superimposing a superimposed signal on a driving signal that drives an optical beam radiating unit for radiating an optical beam, and outputting the driving signal, on which the superimposed signal is imposed, to the optical beam radiating unit; a reference clock signal generating unit for generating a reference clock signal; and a control unit for keeping a frequency of the superimposed signal constant on a basis of a feedback system utilizing the reference clock signal thus generated, thus enabling information to be recorded and/or reproduced utilizing the optical beam radiated.

### BRIEF DESCRIPTION OF THE DRAWINGS

FIG. 1A is a graph showing problems included in the conventional prior art in case where a red laser diode is utilized, and FIG. 1B is a graph showing problems included in the conventional prior art in case where a blue-violet laser diode is utilized;

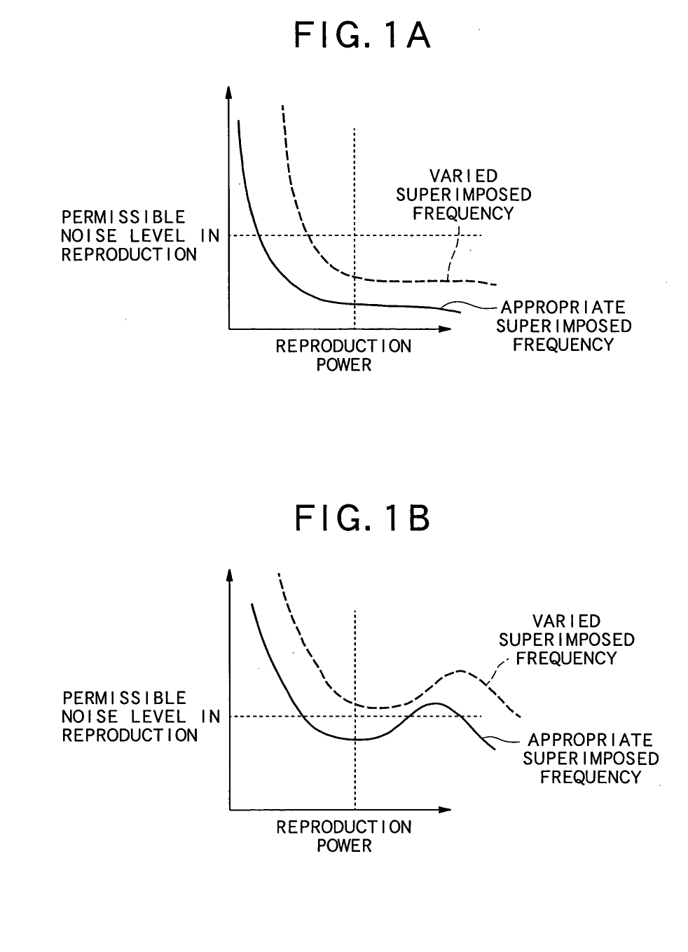

FIG. 2 is a block diagram showing a schematic structure of the driving device according to an embodiment of the present invention; and

FIG. 3 is a flowchart showing an operation to make the frequency stable in the driving device according to the embodiment of the present invention.

### DESCRIPTION OF THE PREFERRED EMBODIMENTS

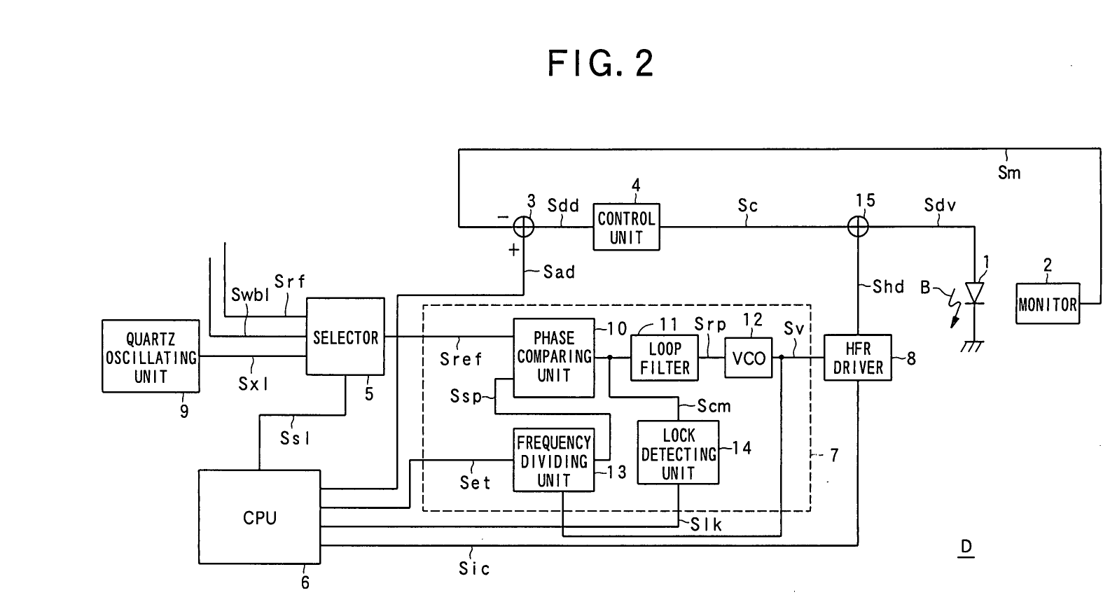

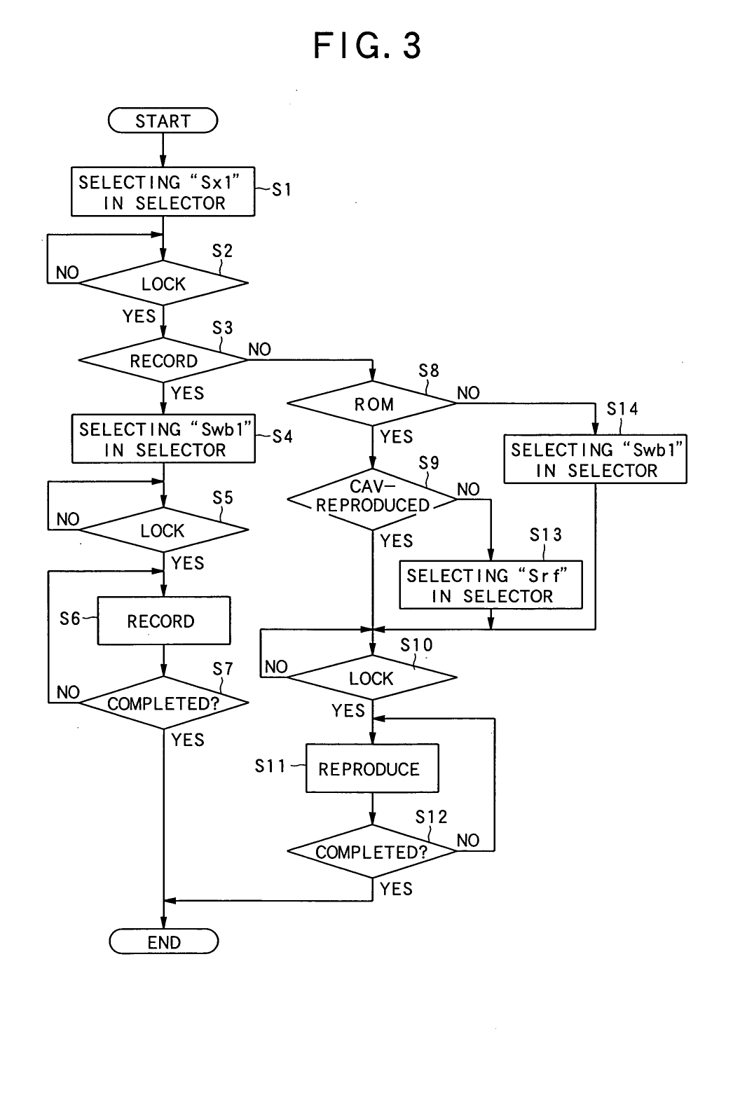

Now, preferred embodiments of the present invention will be described in detail below with reference to FIGS. 2 and 3.

In the embodiment described below, the present invention is applied to the driving device for driving a blue-violet laser diode provided in an information recording/reproducing apparatus that permits to record information on a recordable optical disc and reproduce the information therefrom, as well as reproduce information from are production-only optical disc. This type of driving device superimposes a superimposed signal having a high frequency on a driving signal for driving a laser diode to oscillate the laser diode in a multiple-mode, thus reducing noise in a laser beam radiated by the laser diode.

FIG. 2 is a block diagram showing a schematic structure of the driving device according to an embodiment of the present invention; and FIG. 3 is a flowchart showing an operation of the driving device.

As shown in FIG. 2, the driving device “D” according to the embodiment of the present invention includes a blue-violet laser diode (hereinafter simply referred to as the “laser diode”) 1 serving as an optical beam radiating unit, a monitor 2, a subtracter 3, a control unit 4, a selector 5 serving as a reference clock signal generating unit, a CPU 6, a PLL circuit 7 serving as a control device, a HF (High Frequency) driver 8, a quartz oscillator 9 serving as a quartz oscillating section, and an adder 15 serving as a superimposing unit.

The PLL circuit 7, which serves as a phase-locked loop unit, includes a phase comparing unit 10, a loop filter 11, a VCO (Voltage-Controlled Oscillator) 12, a frequency divider 13 serving as a frequency dividing section 13 and a lock detecting unit 14.

Now, description will be given below of the structural elements.

First, when a not-shown optical disc is loaded into the information recording/reproducing apparatus to record information on the disc or reproducing the information therefrom, a driving signal “Sc” for driving the laser diode 1 is generated in the control unit 4. Then, a superimposed signal “Shd” described later supplied from the HF driver 8 is added to the driving signal “Sc” in the adder 15. The driving signal “Sc” to which the superimposed signal “Shd” has been added, is outputted in the form of adding driving signal “Sdv” to the laser diode 1. Accordingly, the laser diode radiates a blue-violet laser beam “B” to be directed to the information recording surface of the optical disc through a not-shown objective lens.

A monitor 2, which is disposed in the vicinity of the laser diode 1, receives apart of the optical beam “B” radiated from the laser diode 1, and then generates a monitor signal “Sm” corresponding to the receiving intensity of the optical beam. The monitor signal is outputted to one of the terminals of the subtracter 3.

A target value signal “Sad”, which is indicative of a target value of an output power of the laser diode 1 (namely, intensity of the optical beam “B”), is inputted from the CPU 6 to the other of the terminals of the subtracter 3. The subtracter 3 subtracts the monitor signal “Sm” from the target value signal “Sad” to generate a difference signal “Sdd”, which is indicative of the difference between them. The difference signal is fed back to the control unit 4.

Accordingly, a feedback circuit, which is composed of the control unit 4, the adder 15, the laser diode 1 the monitor 2 and the subtracter 3, provides a feedback control so that the optical beam “B” is radiated from the laser diode 1 at the intensity corresponding to the target value indicated by the target value signal “Sad”.

On the other hand, the PLL circuit 7 performs, under the control of the CPU 6, the function of stabilizing the frequency of the superimposed signal “Shd” with the use of the reference clock signal “Sref”, which is outputted from the selector 5.

More specifically, the phase comparing unit 10 in the PLL circuit 7 compares the phase of the above-mentioned reference clock signal “Sref” with the phase of the frequency dividing signal “Ssp” supplied from the frequency divider 13, to generate a comparison signal “Scm”, which is indicative of the difference between them. The comparison signal is outputted to the loop filter 11 and the lock detecting unit 14.

The lop filter 11 removes high frequency components from the comparison signal “Scm” and outputs a filtered signal “Srp” to the VCO 12.

The VCO 12 generates an oscillation signal “Sv” having the frequency, which corresponds to voltage of the filtered signal “Srp” and output such an oscillation signal to the HF driver 8, as well as feeds it back to the frequency divider 13.

The HF driver 8, which has the same frequency as the oscillation signal “Sv”, generates the superimposed signal “Shd” having the amount of electric current, which is indicated by an electric current setting signal “Sic” supplied from the CPU 6, and outputs the superimposed signal to the adder 15. It is possible for the laser diode 1 to become operable in the multiple-mode by adding the superimposed signal “Shd” to the driving signal “Sc” and then driving the laser diode 1, thus reducing noise included in the laser beam “B”.

On the other hand, the frequency dividing section 13 to which the oscillation signal “Sv” is fed back, carries out a frequency division of the oscillation signal “Sv” on the basis of the frequency of the superimposed signal “Shd”, which is indicated by a frequency setting signal “Sset” supplied from the CPU 6 (namely on the basis of the superimposed frequency for the laser diode 1), to generate the above-mentioned frequency dividing signal “Ssp”. The frequency dividing signal “Ssp” thus generated is outputted to the phase comparator 10.

The lock detecting unit 14 to which the comparison signal “Scm” is imputed, continuously monitors a difference in phase between the frequency dividing signal “Ssp” and the reference clock signal “Sref” indicated by the comparison signal “Scm”. More specifically, the lock detecting unit 14 detects a state in which the phase difference becomes almost null, thus providing a detection result that the frequency of the oscillation signal “Sv” (namely, the frequency of the superimposed signal “Shd”) is stabilized. The lock detecting unit 14 generates, after detection of stabilization, a detection signal “Slk” that is indicative of stabilization detected, and outputs it to the CPU 6.

The selector 5 to which a quartz oscillation signal “Sxl” outputted from the quartz oscillator 9, a wobbling clock signal “Swbl” outputted from a not-shown a recording clock signal generating unit and an RF (Radio Frequency) reproduction clock signal “Srf” supplied from a not-shown reproduction clock signal generating unit are imputed, performs a switching operation for these signals on the basis of the control signal “Ssl” supplied from the CPU 6, to output any one of these signals to the phase comparing unit 10 in the form of reference clock signal “Sref”.

The quartz oscillation signal “Sxl” may be utilized as a standard clock signal by which operation of the other structural elements of the information recording/reproducing apparatus than the driving device “D” according to the embodiment of the present invention can be controlled.

The wobbling clock signal “Swbl”, which is obtained by detecting, when recording information on a recordable optical disc or reproducing the information therefrom, a wobbling frequency in the wobbling track formed on the optical disc, in the above-mentioned recording clock signal generating unit, has the frequency that is synchronized accurately with rotation of the recordable optical disc.

In case where information that has already been recorded on a recordable optical disc is reproduced, a reproduction clock signal, which is obtained by extracting a synchronization signal detected during the reproduction of the information (i.e., the synchronization signal included in the information as already recorded), may be substituted for the above-mentioned wobbling clock signal “Swbl”.

The RF reproduction clock signal “Srf”, which is obtained by detecting an occurrence period (a detection period) of the synchronization signal, which is included in the RF signal that has been detected when reproducing information from a reproduction-only optical disc, in the above-mentioned reproduction clock signal generating unit, has the frequency that is synchronized accurately with rotation of the reproduction-only optical disc.

In parallel with the operations of the above-mentioned structural elements, the CPU 6 generates the above-mentioned control signal “Ssl”, electric current setting signal “Sic”, target value signal “Sad” and frequency setting signal “Sset”, and inputs these signals to the structural elements. The CPU 6 has also control over other structural elements (not shown) Now, description will be given below in detail of an operation of recording/reproducing information, which is executed, under control of the CPU 6, by the driving device “D” having the above-described structure, with reference to FIGS. 2 and 3.

In the information recording/reproducing operation according to the embodiment of the present invention, a switching operation is carried out in the selector 5 so that the quartz oscillation signal “Sxl” is selected to output the signal in the form of reference clock signal “Sref” (Step S1). It is then confirmed whether or not the frequency of the superimposed signal “Shd” has been stabilized through the reference clock signal “Sref” (Step S2).

When the frequency of the superimposed signal “Shd” has not been stabilized as yet (No in Step S2), the feedback operation is carried out in the PLL circuit 7 until the frequency is stabilized. On the other hand, when the frequency of the superimposed signal “Shd” has been stabilized (YES in Step S2), it is then confirmed whether or not a subsequent operation to be executed in the information recording/reproducing apparatus according to the embodiment of the present invention is an operation of recording information on a recordable optical disc, on the basis of judgment results on the types of discs in a not-shown disc-type judging unit (Step S3).

In case where the subsequent recording operation is executed (YES in Step S3), a switching operation is carried out in the selector 5 so that the wobbling clock signal “Swbl” is selected to output the signal in the form of reference clock signal “Sref” (Step S5). It is then confirmed whether or not the frequency of the superimposed signal “Shd” has been stabilized through the reference clock signal “Sref” (Step S5).

When the frequency of the superimposed signal “Shd” has not been stabilized as yet (No in Step S5), the feedback operation is carried out in the PLL circuit 7 until the frequency is stabilized. On the other hand, when the frequency of the superimposed signal “Shd” has been stabilized (YES in Step S5), an operation is carried out to record information on the recordable optical disc (Step S6). It is then confirmed whether or not the recording operation has been completed in a required manner (Step S7).

In case where the recording operation has not been completed in the required manner (NO in Step S7), the recording operation is continued. On the other hand, in case where the recording operation has been completed in the required manner (YES in Step S7), a serried of operations is finished.

Alternatively, in case where it is judged in the above-mentioned Step S3 that any subsequent recording operation is not to be executed, namely, a subsequent reproducing operation is to be executed (No in Step S3), it is then confirmed whether or not an optical disc, which is loaded, as a disc from which information is to be reproduced in the reproduction operation, into the information recording/reproducing apparatus, is a reproduction-only optical disc, on the basis of judgment results on the types of discs in the above-described disc-type judging unit (Step S8).

When it is judged that the optical disc as loaded is the reproduction-only optical disc (YES in Step SB), it is then confirmed whether or not a rotation control is made at a CAV (Continuous Angular Velocity) for the reproduction-only optical disc (Step S9).

In case where the CAV rotation control is made (YES in Step S9), the quartz oscillation signal “Sref” as currently applied is used, without modification, as the reference clock signal “Sref”, on the grounds that use of the RF reproduction signal “Srf” as the reference clock signal “Sref” may not stabilize the frequency of the superimposed signal “Shd” due to variation of the frequency in itself of the RF reproduction clock signal “Srf” along with reproduction of the CAV. Accordingly, it is confirmed whether or not the frequency of the superimposed signal “Shd” has been stabilized through the reference clock signal “Sref” (Step S10).

When the frequency of the superimposed signal “Shd” has not been stabilized (NO in Step S10), the feedback operation is carried out in the PLL circuit 7 until the frequency is stabilized. On the other hand, when the frequency of the superimposed signal “Shd” has been stabilized (YES in Step S10), an operation is carried out to reproduce information from the reproduction-only optical disc (Step S11). It is then confirmed whether or not the reproducing operation has been completed in a required manner (Step S12).

In case where the reproducing operation has not been completed in the required manner (NO in Step S12), the reproducing operation is continued. On the other hand, in case where the reproducing operation has been completed in the required manner (YES in Step S12), a serried of operations is finished.

Alternatively, in case where it is judged in the above-mentioned Step S9 that the CAV rotation control is not to be made (NO in Step S9), a switching operation is carried out in the selector 5 so that the RF reproduction clock signal “Srf” is selected to output the signal in the form of reference clock signal “Sref” (Step S13), on the grounds that there is no occurrence of the above-described problem of variation of the frequency in itself of the RF reproduction clock signal “Srf”, and the RF reproduction clock signal “Srf” has the frequency that is synchronized accurately with rotation of the reproduction-only optical disc. Then, the above-mentioned Step S10 and the subsequent steps are carried out.

When it is judged in the above-mentioned Step S8 that the optical disc as loaded is not the reproduction-only optical disc (NO in Step S8), with the result that an operation of reproducing information already recorded on the recordable optical disc is to be subsequently carried out, a switching operation is carried out in the selector 5 so that the wobbling clock signal “Swbl” is selected to output the signal in the form of reference clock signal “Sref” (Step S14), on the grounds that the wobbling clock signal “Swbl” has the frequency that is synchronized accurately with rotation of the recordable optical disc. Then, the above-mentioned Step S10 and the subsequent steps are carried out.

According to the driving device “D” of the embodiment as described in detail of the present invention, a control is made to keep the frequency of the superimposed signal “Shd” constant for stabilization thereof on the basis of the feed back system utilizing the reference clock signal “Sref”, thus making it possible to prevent the frequency itself of the superimposed signal “Shd” for noise reduction from becoming unstable to cause the noise in the optical beam “B”.

Keeping the frequency of the superimposed signal “Shd” constant with the use of the PLL circuit 7 enables the structure to be simplified, thus providing the driving device utilizing the simple elements for general purpose applications.

In addition, generating the reference clock signal “Sref” on the basis of the signal that varies depending upon a type of optical disc on which the optical beam “B” is radiated makes it possible to carry out at least one of operations of recording information on the optical disc and reproducing the information therefrom in an accurate manner in correspondence with the type of the optical disc.

Further, generating the reference clock signal “Sref” on the basis of the signal that varies depending upon any one of operations, which are to be carried out, of recording information on an optical disc on which the optical beam “B” is radiated and of reproducing the information from the optical disc utilizing the optical beam “B” makes it possible to apply the most suitable reference clock signal “Sref” in correspondence with the operation, which is to be carried out with the use of the reference clock signal “Sref”, thus achieving at least one of record and reproduction of information in an accurate manner.

When the reference clock signal “Sref” is generated with the use of the quartz oscillation signal “Sxl” from the quartz oscillating section 9, the stabilized reference clock signal “Sref” can be generate at any time.

When the reference clock signal “Sref” is generated with the use of the wobbling clock signal “Swbl”, which is extracted from the recordable optical disc, it is possible to generate the stabilized reference clock signal “Sref” in correspondence with conditions such as rotation of the optical disc. In addition, even when the driving device “D” according to the embodiment of the present invention is incorporated into an IC (Integrated Circuit) chip together with the other elements in which such a wobbling clock signal “Swbl” can be utilized, a common use of the wobbling clock signal “Swbl” permits a stable generation of the reference clock signal “Sref”.

When the reference clock signal “Sref” is generated with the use of the RF reproduction clock signal “Srf”, which is extracted from the reproduction-only optical disc, it is possible to generate the stabilized reference clock signal “Sref” in correspondence with conditions such as rotation of the optical disc. In addition, even when the driving device “D” according to the embodiment of the present invention is incorporated into an IC (Integrated Circuit) chip together with the other elements in which such an RF reproduction clock signal “Srf” can be utilized, a common use of the RF reproduction clock signal “Srf” permits a stable generation of the reference clock signal “Sref”.

When it is configured that the frequency division ratio in the frequency dividing section 13 can be modified through the frequency setting signal “Sset” from the CPU 6, the frequency of the superimposed signal “Shd” can be controlled through the control of the frequency division ratio, thus making it possible to control the frequency with a simple structure.

In such a case of controlling the frequency division ratio, the frequency of the superimposed signal “Shd” is controlled through both of the frequency of the reference clock signal “Sref” and the frequency division ratio, thus making it possible to control the frequency in a wider range.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-341549 filed on Sep. 30, 2003 including the specification, claims, drawings and summary is incorporated herein by reference in its entirety.

1. A driving device comprising:
a superimposing unit for superimposing a superimposed signal on a driving signal that drives an optical beam radiating unit for radiating an optical beam, and outputting the driving signal, on which the superimposed signal is imposed, to the optical beam radiating unit;
a reference clock signal generating unit for generating a reference clock signal; and
a control unit for keeping a frequency of the superimposed signal constant on a basis of a feedback system utilizing the reference clock signal thus generated.

2. The device as claimed in claim 1, wherein:
said control unit is a phase-locked loop unit that keeping the frequency constant based on the reference clock signal.

3. The device as claimed in claim 1, wherein:
the reference clock signal generating unit generates the reference clock signal on a basis of a signal that varies depending upon a kind of recording medium on which the optical beam is radiated.

4. The device as claimed in claim 1, wherein:
the reference clock signal generating unit generates the reference clock signal on a basis of a signal that varies depending upon any one of operations, which are to be carried out, of recording information on a recording medium utilizing the optical beam and of reproducing the information from the recording medium utilizing the optical beam.

5. The device as claimed in claim 1, wherein:
the reference clock signal generating unit comprises a quartz oscillating section to generate the reference clock signal.

6. The device as claimed in claim 1, wherein:
the reference clock signal generating unit generates, when recording information on a recording medium with a wobble track, which permits an optical record/reproduction of information, utilizing the optical beam and reproducing the information from the recording medium utilizing the optical beam, the reference clock signal on a basis of a wobbling clock signal obtained by detecting a wobbling frequency in the wobble track.

7. The device as claimed in claim 1, wherein:
the reference clock signal generating unit generates, when reproducing information from a reproduction-only optical recording medium utilizing the optical beam, the reference clock signal on a basis of a reproduction clock signal obtained by reproducing the information.

8. The device as claimed in claim 1, further comprising:
a frequency control unit for modifying a frequency division ratio in a frequency dividing section included in the phase-locked loop unit, to control the frequency.

9. The device as claimed in claim 8, wherein:
the frequency control unit controls the frequency based on the frequency of the reference clock signal and the frequency division ratio.

10. An information processing apparatus comprising:
a driving device comprising:
a superimposing unit for superimposing a superimposed signal on a driving signal that drives an optical beam radiating unit for radiating an optical beam, and outputting the driving signal, on which the superimposed signal is imposed, to the optical beam radiating unit;
a reference clock signal generating unit for generating a reference clock signal; and
a control unit for keeping a frequency of the superimposed signal constant on a basis of a feedback system utilizing the reference clock signal thus generated, thus enabling information to be recorded and/or reproduced utilizing the optical beam radiated.
